(19) United States
(12) Patent Application Publication
(10) Pub. No.: US 2013/0184838 A1
(43) Pub. Date: Jul. 18, 2013

(54) RESOURCE OPTIMIZATION USING ENVIRONMENTAL AND CONDITION-BASED MONITORING

(71) Applicant: Michigan Aerospace Corporation, Ann Arbor, MI (US)

(72) Inventors: Peter TCHORYK, JR., Ann Arbor, MI (US); Matthew J. Lewis, Ann Arbor, MI (US); Charles J. Richey, Ann Arbor, MI (US); David K. Johnson, Ann Arbor, MI (US); David M. Zuk, Ann Arbor, MI (US)

(73) Assignee: Michigan Aerospace Corporation, Ann Arbor, MI (US)

(21) Appl. No.: 13/736,000

(22) Filed: Jan. 7, 2013

Related U.S. Application Data
(60) Provisional application No. 61/583,976, filed on Jan. 6, 2012.

(51) Int. Cl. G05B 13/04; F03D 7/00

(52) U.S. Cl. CPC G05B 13/042; F03D 7/00
USPC 700/31

(57) ABSTRACT

In a method for dynamically optimizing resource utilization in a system over time according to one or more objectives, data including information indicative of current environmental conditions, upcoming environmental conditions, a current state of a system configuration, and current system operating conditions is dynamically updated. Automatic analysis of the data using a probabilistic model based on conditional relationships is performed periodically. For each periodically generated set of possible system control actions, a probabilistic model is used to automatically analyze each possible system control action and an optimal system control action is selected based on a set of current utility functions. For each periodically generated set of possible system control actions, control of the system according to the optimal system control action selected from the possible system control actions. Resource optimization couples condition-based and environmental monitoring with automated reasoning and decision making technologies, to develop real time optimal control and decision strategies.

This application claims priority to U.S. Provisional Application No. 61/583,976 filed on Jan. 6, 2012, which is hereby incorporated by reference.

### I. BACKGROUND OF THE INVENTION

### Field of the Invention

The present invention relates to a system and method for integrating condition monitoring, sensor, and system configuration information to optimize resources over time according to one or more objectives.

### RESOURCE OPTIMIZATION

The goal of resource optimization is to make use of limited resources to optimize one or more objectives. In a sense, the problem may be regarded as a one of optimal decision making in the presence of uncertainty. When provided data, constraints, and objectives, resource optimization seeks to make decisions that optimize the stated objectives.

Consider as an example the problem of wind energy. The goal of the wind energy industry is to generate electrical power from captured wind energy. The limited resource is the wind itself, and one wishes to maximize the energy extracted from this wind, while minimizing the cost of doing so. To solve this problem, one must make a number of decisions, involving the design and operation of wind turbines, where to place the wind farm fo optimally exploit seasonal wind patterns, where to place turbines on the wind farm, how frequently to maintain and upgrade turbines, and so on.

In most cases, decisions made by people and machines are suboptimal because they do not exploit all available information. Sometimes this is because there are insufficient sources of data—not enough sensors, for instance—but often it is because it is difficult to intelligently and consistently reason about large amounts of diverse data.

Furthermore, the notion of optimality may evolve in time. Resource optimization involves designing a system or process to be as good as possible with respect to a well-defined set of metrics, preferences, and constraints. Decisions that are optimal in one context may very well be suboptimal in another, where different metrics and preferences prevail. Because constraints, risks, and the environment are always changing, resource optimization must be a time dependent activity.

### II. SUMMARY OF THE INVENTION

In at least a first preferred embodiment, the present invention is directed to a method for dynamically optimizing resource utilization in a system over time according to one or more objectives. The steps of the method incorporate dynamically updating a set of data including information indicative of current environmental conditions, upcoming environmental conditions, a current state of a system configuration, and current system operating conditions; periodically performing an automatic analysis of the set of data using a probabilistic model that is based on a set of conditional relationships defined between current environmental conditions, upcoming environmental conditions, system configuration states, and system operating conditions to periodically generate a set of possible system control actions; for each periodically generated set of possible system control actions, using the probabilistic model to automatically analyze an outcome of each possible system control action and select an optimal system control action from the set of possible system control actions based on a set of current utility functions formulated according to system performance priorities; and for each periodically generated set of possible system control actions, performing control of the system according to the optimal system control action selected from the set of possible system control actions.

The invention's approach to resource optimization couples condition-based and environmental monitoring with automated reasoning and decision making technologies, to develop real time optimal control and decision strategies. The invention will be described hereinbelow in terms of specific applications to the design and construction of Smart Wind Turbines, Smart Buildings, and illustrate briefly how the strategies extend to the notion of Smart Business Analytics. The approach is also applicable to other areas, such as situational awareness and threat detection for security purposes, among others.

### Smart Wind Energy

As wind turbine rotor diameters increase in size, especially for offshore wind farms, susceptibility to damaging wind conditions is also increasing. The extreme and fatigue loads that a turbine must endure increase the Cost of Energy (CoE) significantly through higher maintenance and repair costs, reduced availability, shorter lifetimes and increased initial purchase cost due to the need for greater design margin. These problems are exacerbated for larger turbines and when major repairs require cranes to replace damaged components.

In order to fully capitalize on the delivery of wind energy to the power grid, unexpected wind turbine down-time due to equipment failure must be minimized. Deployed turbines typically have numerous sensors collecting information from subsystems such as the blades, gearbox, lube oil, and the drive train. The wind energy community has invested heavily in various Condition Monitoring (CM) systems to process turbine subsystem sensor data to predict failures before they occur. While success has been achieved in monitoring isolated turbine elements, the community has made few attempts to develop a comprehensive picture of the wind energy problem across all its important scales.

Critical information about the health of the wind energy ecosystem exists across many scales. This includes: (1) individual wind turbine components such as the gearbox, blades, generator, and so on; (2) the wind turbine as a system, in terms of its incident wind field, power output, and structural vibrations; (3) the wind farm as a whole; (4) the power grid; and (5) the atmosphere itself, including climate and weather patterns. By processing and fusing sensor and auxiliary information across all levels, we may develop a comprehensive, real-time situational awareness of the wind energy problem.

This multi-scale situational awareness can feedback directly into the wind turbine control systems (to prevent, for example, turbine damage during extreme wind events), but it can also identify when specific components are likely to fail, help develop optimal maintenance schedules, and more accurately estimate the expected power output of a given turbine or farm over time.

### Smart Turbines

The state of the art in wind turbine Condition Monitoring (CM) is confined to analysis of individual subsystems, with specialized analyses designed for each. Furthermore, the results of this limited monitoring are rarely explicitly integrated into turbine control systems, maintenance scheduling, or wind farm and power grid optimization.

The Smart Turbine system of the present invention extends this limited notion of condition monitoring. The present invention combines condition monitoring across all scales of the wind ecosystem with innovative atmospheric Light Detection and Ranging (LIDAR) measurements and fault tolerant control strategies to develop turbines and wind farms that are more predictable, deliver more power, and have a lower cost of energy.

This is achieved by integrating three key pieces of technology: (1) Advanced reasoning and decision making strategies utilizing Bayesian networks and influence diagrams; (2) Innovative UV LIDAR technology for making precision measurements of the wind flow field in advance of the turbine, thereby improving condition monitoring and load mitigation (both extreme and fatigue); and, (3) advanced control strategies (e.g., fault tolerant) that translate input from the decision making, condition monitoring, and LIDAR systems to actively control individual turbines to limit wear and tear and failures, while delivering maximum power output.

The Advanced Condition Monitoring framework of the present invention provides a practical system for integrating diverse sources of information in order to develop the comprehensive picture described above. It may use existing condition monitoring technology as input, as well as information about seasonal wind pattern variations and current weather data. Additionally, technologies such as UV LIDAR sensors can be seamlessly integrated into the CM picture, providing new, feed-forward control capabilities and real-time insight into the state of wind turbines and farms.

### Smart Building Management

According to the U.S. Department of Energy (DoE), commercial buildings consume nearly 20% of all energy used in the United States. For commercial property managers, electricity costs now ranks as the number one or two largest operating expenses. Commercial buildings are notoriously inefficient, with an average building operating 15-30% out of specifications, wasting enormous amounts of energy and money.

As buildings are fitted with advanced sensors and more responsive, configurable HVAC and lighting systems, they will require sophisticated nonlinear, time adaptive control strategies in order to actively minimize energy consumption while providing sufficient heat and light to building users. The reasoning and decision making tools of the claimed invention can provide a consistent scalable framework for modeling and managing smart buildings.

### Smart Business Analytics

Finally, the reasoning and decision technology of the present invention is not limited in application to physical devices such as wind turbines or HVAC systems. Businesses themselves are incredibly complicated machines, and they often run on suboptimal decisions: Business decisions are made every day without global perspective, without making use of available data, using isolated, outdated spreadsheets, and seat-of-the-pants intuition.

The present invention can provide a framework for making intelligent business decisions. An innovative front end framework allows users to build sophisticated models of the business environment, exploring the impact of different decisions and quickly simulating a vast number of possible business strategies. Utility functions may be added to quantify what is important, and decisions can be made to optimize those utility functions.

### III. BRIEF DESCRIPTION OF THE DRAWINGS

The invention will now be described more particularly with reference to the accompanying drawings which show, by way of example only, preferred embodiments of resource optimization according to the invention, wherein:

FIG. 1 illustrates an example Bayesian network related to the wind turbine blade loading problem according to the present invention;

FIGS. 2A and 2B illustrate the Bayesian network of FIG. 1 augmented with a weather forecast node that is influenced by additional factors, including wind speed and wind shear nodes;

FIG. 3 shows the Bayesian network of FIG. 2, augmented with decision and utility nodes to become an influence diagram;

FIGS. 4A-4C illustrate a dynamic influence diagram wherein, as new data becomes available, the influence diagram evolves in time;

FIG. 5 illustrate, on the left, probability distributions of wind speed (top) and high speed shaft torque (bottom), and on the right, the likelihood of torque given windspeed, so as to detect anomalous regions in the data;

FIG. 6 illustrates an analysis of SCADA data coming from a turbine;

FIG. 7 illustrates an Independent Sample Synthesis (ISS) for anomaly detection;

FIGS. 8A and 8B illustrate example views of ISS effects in data, and the trajectory away from normal behavior over time, respectively;

FIG. 9A illustrates a general embodiment of the resource optimization system of the present invention;

FIG. 9B illustrates an embodiment of the resource optimization system of the present invention as implemented in connection with a LIDAR system of the present invention;

FIG. 10 shows a functional overview of a UV Direct Detection LIDAR;

FIG. 11 an example instrument that employs range-imaging, direct detection LIDAR technology;

FIG. 12 illustrated an example implementation of the range-imaging, direct detection LIDAR technology of FIG. 11;

FIG. 13 illustrates the range bin sizes for the implementation of FIG. 12;

FIG. 14 shows the range bin distribution for the implementation of FIG. 12;

FIG. 15 illustrates UV LIDAR wind speed measurements compared to a sonic anemometer;

FIG. 16 illustrates an example LIDAR hardware that can be incorporated into the implementation of FIG. 12 in accordance with the present invention;

FIG. 17 illustrates a graphical illustration of the example LIDAR hardware of FIG. 12;

FIG. 18 illustrates CART2 accelerometer data for an emergency stop, during which a strong wind gust caused accelerometer readings to exceed safe operating limits, wherein “Port,” “Starboard,” and “IMU” refer to two locations of traditional 3-axis accelerometers and an inertial motion unit inside the nacelle;

FIG. 19 illustrates a high-level concept showing integrated condition monitoring & LIDAR controller augmenting the traditional feedback strategies, wherein rotor speed is given by w, blade pitch by b, and generator torque by t_{c};

FIG. 20 illustrates unstable LSS torque in CART3, wherein the turbine was stopped by a human operator, but a fault-detection scheme could be designed to eliminate the need for the operator in this scenario;

FIG. 21 shows the sensor locations on CART3, wherein LIDAR may be located on the nacelle behind the blades or inside the hub; and

FIG. 22 illustrates an influence diagram for Smart Building control system.

### IV. DETAILED DESCRIPTION OF THE PREFERRED EMBODIMENTS

### Optimal Reasoning and Decision Making

For concreteness, we describe the reasoning algorithms in the context of the CM technology of the present invention, but as emphasized in later sections, the reasoning and decision making algorithms are generic and may be used to solve problems in domains beyond that of wind energy.

### Condition Monitoring

At its core, the CM technology of the present invention builds a probabilistic model of the wind energy system, from the level of individual turbine components up to the structure of the atmosphere—at whatever level of resolution is desired, and using whatever data sources are available. This model can then be interrogated to predict, for example, the expected power output of a wind turbine as a function of time, or the likelihood of a given component failing within the next two weeks.

Because the notions of decision making and utility functions may be directly integrated into CM models according to the present invention, however, we may also “solve” the model to select the optimal decision from among a set of possible actions.

As a concrete example, consider the following: in extreme wind conditions, turbines may encounter excessive blade loading and suffer severe damage. One way to avoid this event is to detect the onset of such extreme conditions and deliver a signal to the turbine's control system to “pitch” the turbine blades, thereby shedding load and preventing damage.

Using sensor input from UV LIDAR measurements of the atmosphere (e.g., wind speed and direction), torque measurements from the turbine's own sensor suite, and auxiliary information about prevailing weather patterns, a detailed probabilistic model of the scenario may be constructed. This model can be solved to estimate the optimal decision at a given point in time: [pitch|do not pitch]. The selected decision is optimal with respect to the so-called utility functions, which balance stakeholders' conflicting desires to produce steady power while at the same time limiting the chances of catastrophic (and therefore very expensive) damage to the turbine.

The software implementation of the present invention's CM provides the tools to build, solve, and exploit such probabilistic models. Fundamental to the system of the present invention is the deep integration of the notions of decision making and utility specifications with conventional sensor and auxiliary data sources. This intrinsic integration provides a practical interface between the users/stakeholders and the vast cloud of data associated with the wind energy ecosystem. It allows for automated analysis of the data, while providing a useful visual interface for understanding the chains of probabilistic reasoning that lead to important decisions across all scales of the problem.

Hereinbelow, we present the CM software's theoretical framework, the associated data mining technology, as well as some of the implementation strategies, all of the present invention.

### Bayesian Networks

At the core of the CM software implementation of the present invention is the Bayesian Network (BN). A Bayesian network is a mathematical model that allows for reasoning under uncertain conditions according to the laws of probability. A Bayesian network is a directed acyclic graph (DAG) in which each node contains information about a single random variable, and where links between the nodes indicate a causal (albeit probabilistic) relationship between the random variables:
1. A set of nodes. Each node represents a random variable, which may be discrete or continuous, and which represent the physical phenomena we are modeling.
2. A set of directed links (arrows). These arrows indicate a causal relationship between the nodes that they connect. If an arrow exists from node X to node Y, we say that X is the parent of Y. The set of all parents of a node X is denoted Parents (X).
3. Conditional probability distributions. For each node X, we specify conditional probability distributions P(X|Parents(X)) that that quantify the influence of parents on children.

The structure of the network, its topology—the precise arrangement of the nodes and the links—completely specifies the conditional independence relationships that exist between the variables. If we attempted to characterize the entire joint probability distribution relating these random variables, the problem would be combinatorially intractable. The fact that we need only specify conditional probabilities directly between variables that have a causal relationship renders the problem tractable, and makes the Bayesian network a useful and powerful tool.

### An Example Network

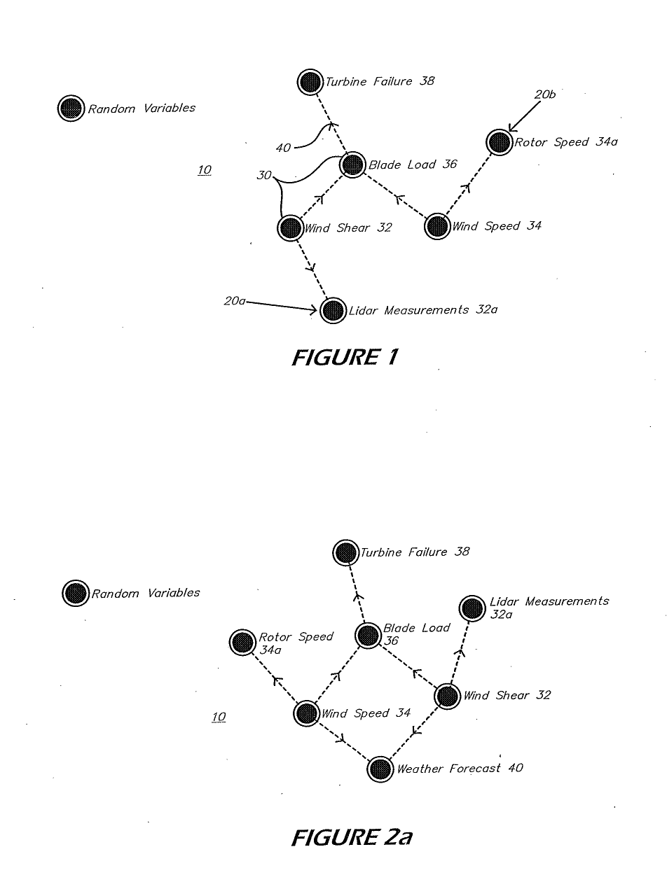

Consider a simple example Bayesian network 10 as shown in FIG. 1: a probabilistic description of the blade loading problem introduced above, wherein the network may be implemented on a computer or computer-based network system that is operatively connected to receive and process data and/or control signals from a variety of data or control signal sources, including but not limited to sensor elements, LIDAR devices, wind turbines, remotely-located controllers, weather database sources, other computers or computer networks, other computer-implemented Bayesian networks and other database sources. Such computer and/or computer-based networks implementing the Bayesian network 10 may be configured and/or programmed with the appropriate control, database and operating system software to function as would be understood by those of skill in the art.

In this example network 10, we have two sensor inputs 20: (1) sensor elements 20a for providing LIDAR measurements of wind shear; and, (2) sensor elements 20b for providing turbine rotor speed measurements. These sensor inputs 20 are modeled as random variable nodes in the network 10 as LIDAR Measurements and Rotor Speed, as shown in FIG. 1.

Nodes 30 are connected to other nodes via an edge 40 in the graph. The edges indicate a causal link between two random variables. More precisely, as indicated above, if node X is the parent of node Y, then it induces a conditional probability density P(Y|X) that produces a dependency between the two random variables. Indeed, a Bayesian network can simply be considered a framework for the efficient representation of conditional probability distributions.

If the LIDAR Measurements node 32a is the child of the Wind Shear node 32, this represents that wind shear is a cause of the observed LIDAR measurements. When the network 10 is constructed, the conditional probability distribution is encoded into the network. This allows us to predict the value of Wind Shear given the LIDAR Measurements, as we will see below. Similarly, if the observed Rotor Speed Measurements node 34a is the child of the Wind Speed node 34, this causal relationship allows the network 10 to predict the Wind Speed based on the Rotor Speed Measurements.

What we are ultimately interested in is likely the probability of turbine failure, as embodied by a Turbine Failure node 38. To estimate this probability, we must model how Wind Shear node 32 and Wind Speed node 34 translate to Blade Load as represented by the Blade Load node 36, and how the Blade Load is fundamentally related to the probability of the Turbine Failure event. These probabilities can be modeled by subject matter experts (SMEs), derived from simulations, or learned in an automated manner from observed data.

Our physical understanding of the problem is encoded in the topology of the Bayesian network. Because the representation is visual in nature, we can easily grasp the assumptions being made. Subject matter experts can identify where the model is insufficient or incorrect. New nodes may be added, and the network may learn new probability distributions as new data become available.

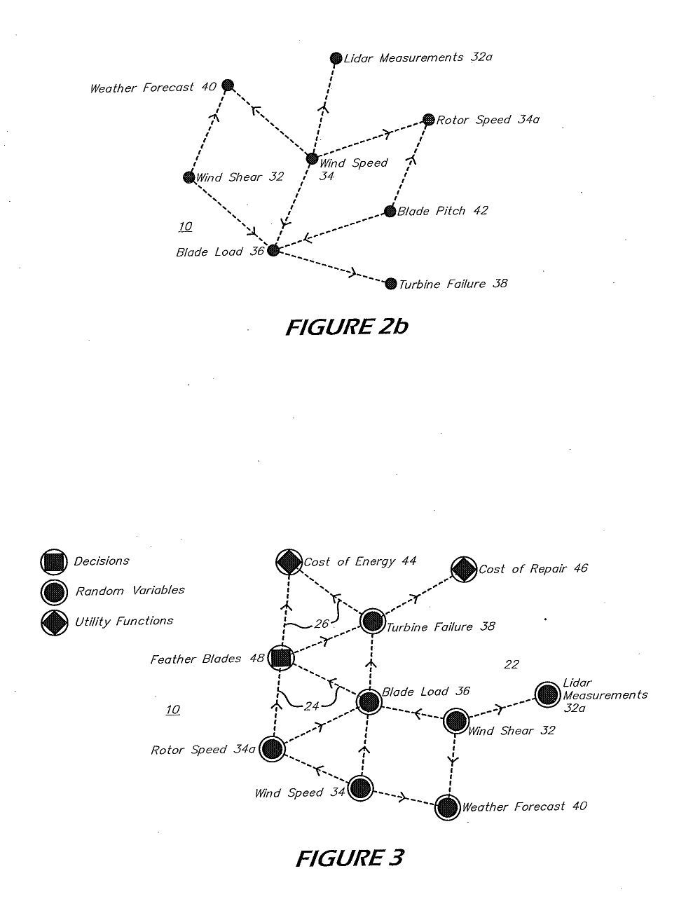

For example, if we are granted access to a weather forecast feed, we can add this data source to the network 10 by introducing a new node, provided we can also model how Weather Forecast, as represented by the Weather Forecast node 40 is influenced by the Wind Speed node 34 and Wind Shear node 32 (see FIGS. 2A and 2B). Further, we can model how Blade Pitch, as represented by the Blade Pitch node 42, influences the Rotor Speed node 34a and/or the Blade Load 36. By adding new information and explicitly ascribing a relationship between physical variables in this way, we can increase the accuracy of our other predictions, including the Turbine Failure event.

### Solving Networks

Once a network 10 has been built, it may be ‘solved’ to estimate the values of the random variables in the network. The typical situation is this: we observe one or more of the variables in the network, and we ask the question, “What are the most probable values of the rest of the network, given these observations.” For instance, in the network described above and shown in FIGS. 2A and 2B FIG. 2, we might observe Rotor Speed, LIDAR Wind Shear, and Weather Forecast, and then ask the question: “Given these observations, what is the probability of Turbine Failure?”

Because the network simply encodes a joint conditional probability distribution among the variables, what we are really asking for is the posterior probability distribution—that is, the joint probability distribution properly updated given we have observed the values of certain variables. The process of computing this distribution is known as probabilistic inference: Given that we understand the probabilistic relationship between a number of variables, an observation of the values of a subset of those variables allows us to infer the values of the others. A key feature of Bayesian networks is that we may recover not only the value of a random variable, but also its distribution. This allows us to understand the uncertainty in our estimates.

There exist a number of techniques for efficiently solving Bayesian networks. For maximum flexibility, the CM technology of the present invention uses a powerful mathematical technique known as Markov Chain Monte Carlo (MCMC) at the core of its inference engine.

MCMC methods are a class of algorithms for sampling from probability distributions based on constructing a Markov chain that has the desired distribution as its equilibrium distribution. The state of the chain after a large number of steps may be used as a sample of the desired distribution. By generating many samples of the distribution, we can compute any statistical quantities desired, including the mean, standard deviation, and higher order moments. In fact, MCMC methods levy no requirements that the underlying distributions be normal Gaussian, or even unimodal. This flexibility makes MCMC methods for probabilistic inference so attractive.

### Influence Diagrams & Intelligent Decisions

Bayesian networks are powerful tools for reasoning probabilistically, but they become even more useful when wedded to intelligent decision making strategies. Bayesian networks integrate sensor, configuration, and other environmental data to provide a coherent model of the system. We can use this representation to make intelligent decisions by helping select actions that will optimize our higher-level goals.

A utility function expresses a preference. It is a function, U(s)→ [symbol] , that maps a state, s, to a single number expressing its desirability: the larger the utility, the more that state is preferred. In many practical cases, the utility is monetary in nature, but may in practice correspond to any scalar quantity.

In order to maximize these utility functions, a number of actions that are available are then represented in the network as decision nodes. Different decisions will, in general, influence the state of random variables in the network, and result in different values of the utility functions.

As shown in FIG. 3, by adding decisions and utilities to the Bayesian network, we form an Influence Diagram (ID). An influence diagram exploits the reasoning capacity of a Bayesian network to allow an agent to act optimally in order to maximize one or more utility functions. This ID represents an extension of the Bayesian network illustrated in FIG. 2. In particular, the network 10 is augmented to include two utility functions, Cost of Energy 44, and the Cost of Repair 46, and a single decision node, Feather Blades 48.

Directed links 22 connecting a parent Random Variable (RV) node to a child RV node indicate a causal influence of the parent on the child, as emphasized hereinabove. A link 24 from an RV into a Decision node, however, denotes that the state of that parent RV must be known when that decision is made. A link 26 from a Decision or RV into a Utility node indicates a functional dependence of the Utility node on the state of that parent Decision or RV.

The Cost of Repair utility function 46 takes as input the Turbine Failure 38 random variable. A catastrophic turbine failure is a very expensive event, and this utility function quantifies the expense. Similarly, the Cost of Energy utility 44 represents the cost of producing a given amount of energy; stakeholders would prefer the (absolute) value of this number to be as small as possible, so the output of the utility function is a negative number (we always maximize utilities). It takes as input the Feather Blades decision node 48, as well as the Turbine Failure random variable 38. If we feather the blades frequently, we are unlikely to stress the system to the point of a catastrophic failure, thereby reducing the Cost of Repair, but we will drive up the Cost of Energy (because we're operating the turbine, but producing no energy). By running the inference engine on the network, we can determine the decision that will maximize the total utility.

This diagram may easily be updated to include many other decision points—maintenance decisions, for example—should we repair or upgrade the turbine at this time? In this case, the system could identify points in time where repairs have little or no impact to the cost of energy as a result of, for instance, seasonally low wind speeds.

In the example of wind turbines, the intended bottom line is straightforward: we wish to minimize the cost of energy. Naively, we might run all turbines at maximum capacity to generate as much power as possible, thereby driving down cost. Unfortunately, doing so in the presence of wind gusts and turbulence can lead to excessive stress on turbine components, leading to higher maintenance costs, and rare catastrophic turbine failures can be extremely expensive events. To minimize the cost of energy, one must balance wind energy production against protecting the turbine itself.

Optimization is always done in the context of available actions. We assume we have, for each state of our system, s, we have available a finite number of actions aᵢεA(s). For wind turbines, one action might be changing the blade pitch. Another might be initiating an emergency stop. A critical point is that optimization must always be done with respect to available actions.

The goal is represented in terms of a scalar reward signal, rₜ, which is a function of the state of the system, sₜ, at time t. The underlying Bayesian network provides the system state at each time t.

The character of the reward signal determines what are the goals. In wind energy production, rₜ can be an estimate of the current cost of energy. A simplistic approach might seek to maximize this signal for each time step. As indicated above, however, the preference is to choose control strategies that optimize long-term returns on our utilities—that is, maximizing not the immediate reward received at each time-step, but the total reward, integrated into the future.

Using techniques of reinforcement learning, most notably Q-learning and SARSA stochastic control schemes, the state information summarized by the Bayesian networks may be used to make sophisticated decisions that move beyond observing utility of the current state.

The core idea behind these more advanced strategies is that, for each state of the system, s, a finite number of actions, aᵢεA(s) are available, and for each state (i.e., state of the Bayesian network), we may select an action from a policy, π(s, a), which is simply the probability that the action taken is a given that the state is s. Associated with every state is a reward, r(s), which implicitly encodes our goals.

Rather than focusing only the reward at hand, we seek to maximize the total discounted return:

Rₜ=rₜ₊₁+γrₜ₊₂+γ²rₜ₊₃+ . . .

where 0≦γ≦1 determines how important future rewards are compared to current rewards. If γ=0, we care only about the present time; if γ=1, all rewards are equally important. Given this idea of return, we define an action-value function:

Q^{π}(s,a)=E_{π}{Rₜ|sₜ=s,aₜ=a}

This is the expected return given that we find ourselves in state s, and we take action a. The stochastic control problem is two-fold: to determine the function, Q^{π}(s, a), and simultaneously to determine the optimal policy, π.

Iterative methods may be used to map the action-value function and the policy, which can be learned via simulations of the system, by learning in real environments, or both simultaneously.

A key advantage to these stochastic control strategies is their ability to learn over time, as new states are encountered, new data is made available, and new actions become accessible. Furthermore, these methods can provide rich, non-intuitive solutions to complex decision making problems that simplistic utility maximization schemes cannot replicate.

Networks within Networks

As new variables, decisions, and utilities are added to an influence diagram representing a network 10, the complexity of the network 10 can grow quickly, making an analysis of its structure difficult. For example, as the structure of the network grows from representing just individual turbine components to the level of a wind farm or to the even more complex level of a power grid, the difficulties in the operation of the network 10 can and will become unmanageable.

To avoid allowing the network 10 from becoming too complex to understand and operate, groups of nodes 30 from the network 10 can be collapsed and represented as a single node on the influence diagram representing the network 10—such collapsed nodes will be called network nodes, which may be incorporated into other, higher-order networks of influence diagrams as if it were any other variable, decision, or utility node. Furthermore, one may identify nodes within a network node as interface nodes—nodes that are exposed as inputs or outputs to the influence diagram contained within the network node. When a network node is used in an influence diagram, these interface nodes are explicitly available, and may be linked to or from as if they were any other standard network nodes.

By building focused, detailed models and assembling them into systems of increasing complexity, one can build well-tested, extremely sophisticated representations that incorporate previously unmanageable levels of detail.

### Dynamic Networks

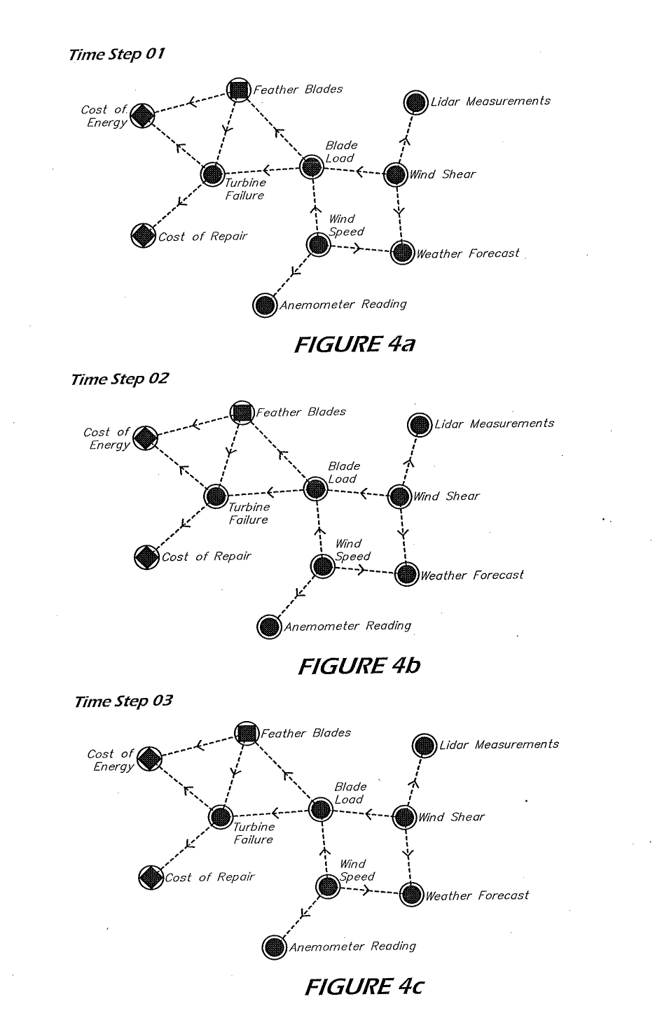

The Bayesian networks and influence diagrams that form the core engine of the present invention's CM system are intrinsically dynamic—that is, they may evolve in time. This is critical, because sensor data sources are constantly updating, and decisions and utility functions must respond accordingly. For models actively changing in time, the algorithm of the present invention breaks the model into a sequence of static influence diagrams, as depicted in FIGS. 4A-4C. As new measurements are made—as new sensor data is made available, for example—the states of the random variables will change. At each time slice, the influence diagram is solved to determine the expected values of all nodes, as well as the optimal set of decisions, given the states of the random variables at that time. In this way, decision making becomes a time dependent activity, with decisions supported and influenced by a constantly changing stream of sensor and auxiliary data.

### Data Mining

The CM system of the present invention also integrates a suite of advanced data mining tools, which may operate on the data sources associated with random variable nodes to produce new network nodes containing processed (and perhaps more useful) data products. These tools include, but are not limited to, clustering, classification, dimensionality reduction, and anomaly detection algorithms. The influence diagram itself also allows the user to extract information from the data in a manner similar to what an explicit data mining effort might attempt.

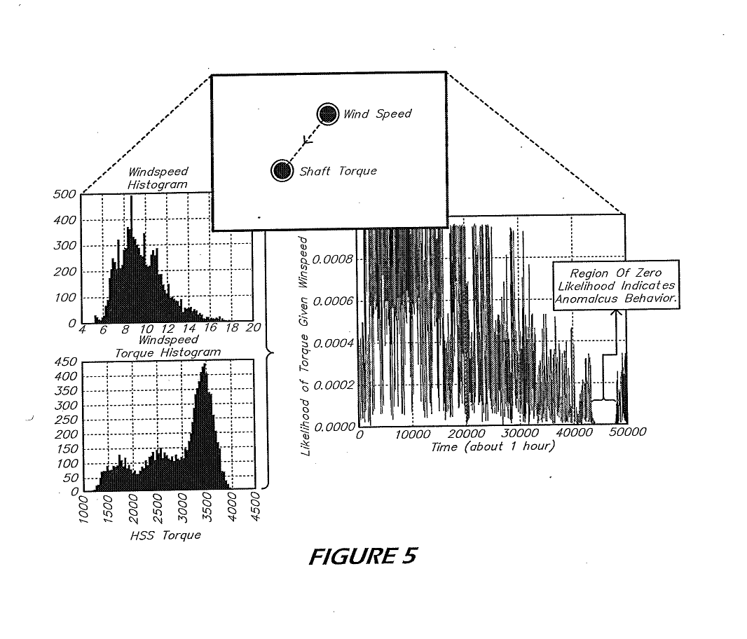

For example, FIG. 5 shows part of an influence diagram involving the causal influence of Wind Speed on Shaft Torque. The histograms on the left show the distribution of wind speed (top) and high speed shaft torque (bottom) for a wind turbine over the course of several hours. On the right, the time-dependent probability of shaft torque given wind speed is encoded directly into the influence diagram.

As shown, in the anomalous region in this time series, it dips to zero as a function of time, between time steps 40,000 and 50,000. This zero probability region indicates an operational anomaly that might indicate a significant problem with turbine operation. This information is implicit in the influence diagram and may be automatically detected and reported to the turbine control systems, or to operators monitoring turbine health.

### Integrating External Data Mining Technologies

The CM framework of the present invention may also integrate other data mining frameworks. For example, the Taiga software from Michigan Aerospace Corporation can provide specialized anomaly detection for sensor data. Taiga software takes data collected by SCADA and produces a signal containing actionable information that may be integrated into a CM framework influence diagram to assist in automated reasoning.

Taiga is a state-of-the-art engine for generating Ensembles of Decision Trees (EDTs) and was previously implemented for NASA. The core components of Taiga are Data Handling, Decision Trees, Decision Tree Ensembles, Model Interpretation and Result Visualization. This software was developed into a flexible data-mining and analysis tool. The inherent flexibility of the EDT approach means that the Taiga system is an ideal approach to anomaly detection within the context of the CM framework of the present invention.

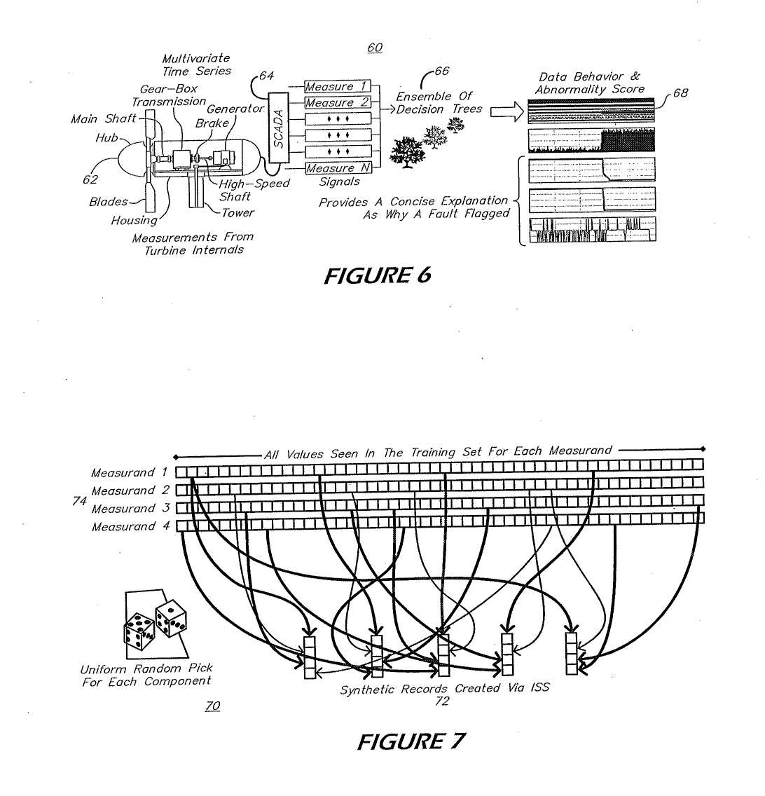

An operational schematic 60 is presented in FIG. 6. Data are collected across all subsystems of a Wind Turbine 62 via a SCADA system 64 and passed to the Ensemble of Decision Tree-based Fault Detection (EDT) algorithms implemented in a control system 66. The EDT training algorithms learn a model of normal turbine behavior. In operation, live data are run against these fault detection models. Developing failures are detected as deviations from the model of expected turbine behavior and then stored in a database 68 including Data Behavior & Abnormality Score, which may be reported to automated response systems and human operators.

Using EDT algorithms for condition monitoring is advantageous because:
The process is nearly turn-key—it is completely data-driven and detectors can be trained rapidly once an adequate amount of normal data has been delineated. No truthing is required, and no hand-made models need to be generated. An operator simply chooses the parameters, feeds the algorithms the data, and waits for the ensemble to be generated.
Prior categories of faults are not necessary—modes are learned as deviations from normal.
If expert operators label faults after discovery, that information can be used to provide more useful down-stream information. As time goes on, these labels capture the essence of major types of faults; then, the problem may be recast as a classification+anomaly detection scheme.
EDT algorithms can be deployed efficiently on architectures ranging from physically-robust embedded systems, FPGAs and GPUs, up to and including servers, clusters and cloud-based systems.
EDT algorithms for CM can be specially-deployed to work in the context of an operator-controlled system or it may be configured for autonomous situations.

Taiga uses EDTs for anomaly detection in an unsupervised learning process which assesses the probability that an unknown record is within a baseline normal class that has been empirically determined from a large body of operational data. There are two modes of analysis. Novelty Detection, or Outlier Analysis, analyzes the data from a single collection in isolation for self-consistency. This mode is diagnostic for examining data post-mortem and detecting issues.

Predictive Modeling or Anomaly Detection is prognostic for finding possible events in independent signals in real time. EDTs provide a robust framework for generating an anomaly detection system.

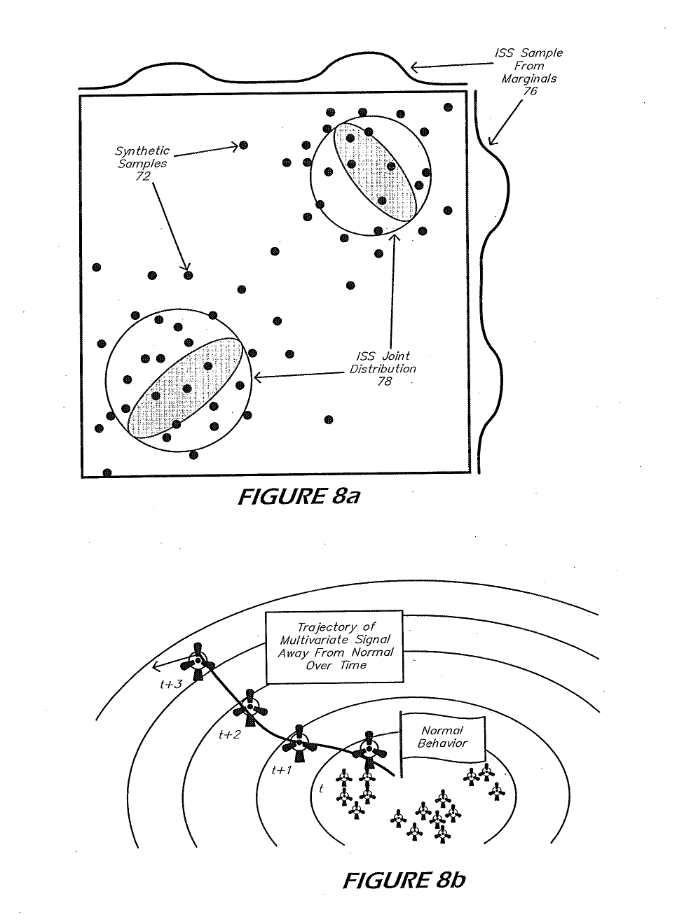

The challenge for anomaly detection is to somehow induce a two-class problem (normal vs. abnormal) using only a set of normal samples. Taiga addresses this challenge using an Independent Sampling Synthesis (ISS) system 70, which creates a synthetic class of abnormal straw-men samples 72 as illustrated in FIGS. 7, 8A and 8B. To make a new synthetic sample, Taiga uniformly and randomly samples from individual training data measurands 74 (i.e., features or dimensions) independently with no emphasis on distribution shape. Therefore, each measurand 74 of the synthetic sample 72 occurs in the training set, but the specific combination of measurand values is unique (e.g. abnormal). The resulting synthetic samples 72 thus have the property that their individual measurand values naturally conform to the distributions of those measurands in the training data, while the assembled samples 76 themselves are highly unlikely to have ever occurred (FIG. 7). Decision trees are trained on the two-class data set, after which the synthetic straw-men samples are discarded, leaving clusters of related normal samples 78.

Taiga's anomaly detection mode applies EDT learning models to obtain an Abnormality Score for operational data as it is presented to the system. This score is based on important concepts related to decision tree evaluation: node co-occurrence, proximity matrix and average proximity, abnormality or outlier measure and sample similarity.

As with all data-driven machine learning processes, as illustrated in FIG. 8B, an adequate and representative dataset is required to train the anomaly detection system. The process for constructing the system is to generate a first-cut model and perform some self-consistency analyses in conjunction with a domain expert in order to filter out any records that we may not want to consider normal. Once the data has been reduced and accepted as nominal, the Day Zero models are constructed and monitoring begins. From this point on, the instance of CM software deployed for that turbine will be able to adapt specifically to it. CM for all models of the same turbine within the same farm could ostensibly be initiated with the same original model; however, these instances will diverge over time based on the local fluctuations in wind, different wear and tear on the components, and other factors that differ between turbines. This is valuable because comparisons can then be made between the outputs of these turbines within the farm to gauge higher-order trends and patterns.

### A Visual Interface

In order to make the construction and evaluation process as easy as possible, to reduce errors, and to allow users to realistically build models of significant complexity, the present invention may be implemented with an intuitive visual, web browser-based interface. The interface allows users to add variable, decision, utility, and network nodes, and interactively establish causal links between those nodes. It allows users to attach data sources directly to nodes, and, critically, the system can automatically learn the probabilistic relationship between parent and children in the network. Furthermore, a user can solve the network at any time, to obtain optimal decisions, and the values of utility functions and random variables. Additional tools allow the user to evaluate network quality, such as sensitivity and conflict analysis, to identify possible problems with the network structure.

### Learning Algorithms

Automated learning algorithms, in particular, are critical to CM usability as implemented in the present invention. The manual construction of networks containing many variables can be extremely tedious, due to the need to specify in detail the conditional probability distributions. Furthermore, networks constructed in this way cannot be easily updated as new data are observed. The present invention provides automated tools for learning the probabilistic relationship between nodes representing both discrete and continuous random variables, and for learning and evaluating the structure of the network itself.

By simply connecting data sources to nodes in a network, the algorithms implemented in the present invention can estimate the underlying probability distributions. Manual construction of the distributions is also possible.

Implementations of the core technology of the present invention include Python and the C/C++ languages, giving the algorithms access to most operating environments and instruments. The system of the present invention also exposes an Application Protocol Interface (API), allowing external systems to remotely access an influence diagram without the need for significant code integration. The external program can supply data to the ID, solve the network, and learn optimal solutions. This can all be managed over standard HTTP or socket interfaces.

Such portability options mean that a user can construct and test a model under the present invention using a convenient visual interface, and then use that model in the field, on real equipment, with minimal integration requirements. It also means that external data sources, such as weather reports, radar, and LIDAR measurements can be readily integrated.

### General System Overview

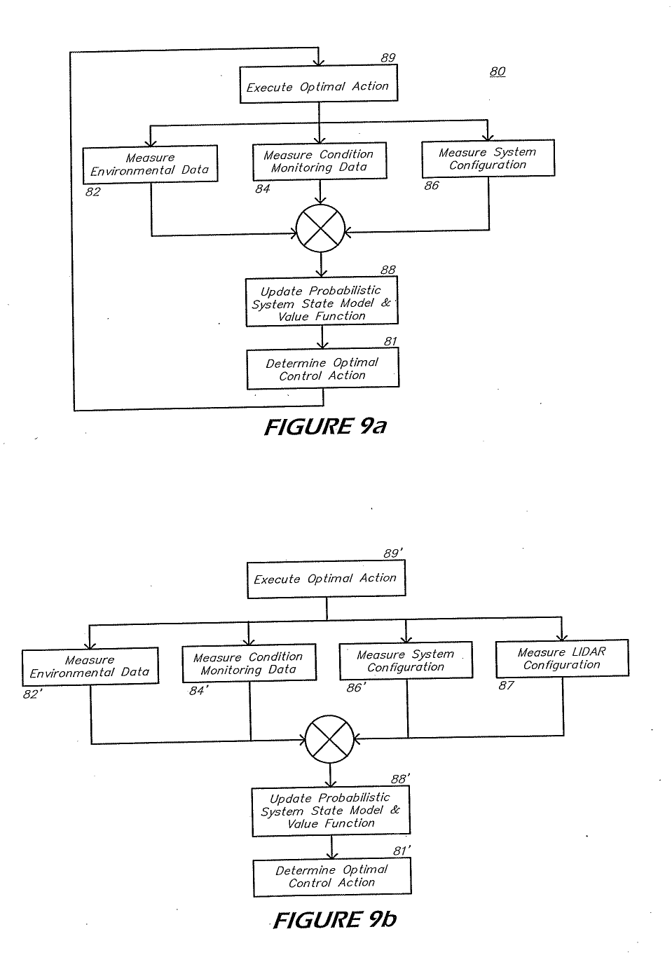

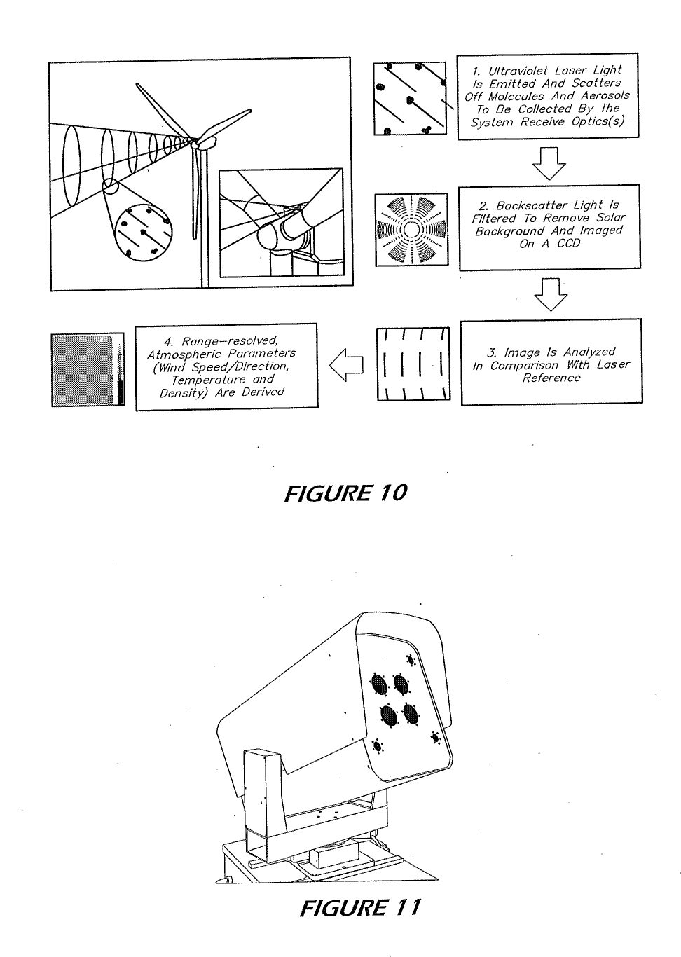

The resource optimization system 80 is outlined in the block diagrams of FIGS. 9A and 9B. At each time-step according to FIG. 9A, measurements are made of the environment 82 as well as system sensor systems 84, and overall system configuration 86. These data are integrated via Bayesian networks to determine the overall state of the system. This state information is used to update the action-value function 88 for the entire system. This action value function updates the higher level control policies, which in turn allow us to select an optimal action 81. This action 89 is executed, and the cycle starts again.

Similarly, according to the block diagram of FIG. 9B, at each time-step, measurements are made of the environment 82′ as well as system sensor systems 84′, overall system configuration 86′, and LIDAR data 87. These data are integrated via Bayesian networks to determine the overall state of the system. This state information is used to update the action-value function 88′ for the entire system. This action value function updates the higher level control policies, which in turn allow us to select an optimal action 81′. This action 89′ is executed, and the cycle of the resource optimization system 80′ starts again.

### Lidar Atmospheric Measurements

Several types of wind LIDAR may be used as input to the system of the present invention. These include, but are not limited to, Ultraviolet (UV) Direct Detection systems using both electronic and geometric ranging, and LIDAR operating at non-UV wavelengths, such as those disclosed in U.S. Pat. Nos. 7,106,447; 7,495,774; 7,505,145; 7,508,528; 7,518,736; 7,522,291; 6,163,380; 6,674,220; 61/171,080; 61/178,550; 61/229,608; and 61/290,004, all of which are hereby incorporated by reference. These LIDAR technologies may be used in conjunction with the condition monitoring and advanced turbine control systems implemented through the present invention in order to reduce loads, extend turbine lifetimes, and potentially increase energy capture.

In addition, UV direct detection technology offers many advantages over other LIDAR technologies currently available, including the ability to have 100% up-time. One of the key differentiators in the use of UV wavelengths is that it enables measurement from air molecules in addition to aerosols, as illustrated in FIG. 10. This allows operation in completely clear air, devoid of aerosols (dust, water vapor, etc.), which can occur after a heavy rainfall, for example, or in environments where aerosol concentration is normally low. The present invention allows the separation of molecular and aerosol return signals, enabling true wind speed measurements during rainfall when the aerosol velocity may differ from the air velocity. Since measurements are made on molecular (Rayleigh) as well as aerosol (Mie) scattering, air temperature and air density can also be determined from the return signal, in addition to air velocity and direction. Turbulence, shear, veer, and other by-product measurements can also be determined.

LIDAR measurements are valuable for the optimization of wind turbine, wind farm, and electrical grid assets. By detecting wind gusts or turbulence at a distance, before the disturbances impact turbine performance, actions to avoid or reduce damage caused by fatigue-induced or extreme loads, including changing the pitch of the turbine blades. In addition to load mitigation, LIDAR measurements can also be used for power curve assessment, yaw control, and site assessment applications. The system of the present invention, in whole or in part, can then be applied to optimize utility functions for these other wind energy applications.

FIG. 11 illustrates one example of a range-imaging, direct detection instrument (specifically, an Opto-SR instrument), that would be mounted on a wind turbine nacelle to characterize wind inflow (gusts, turbulence, and shear) to increase efficiency and reduce mechanical loads on the turbine.

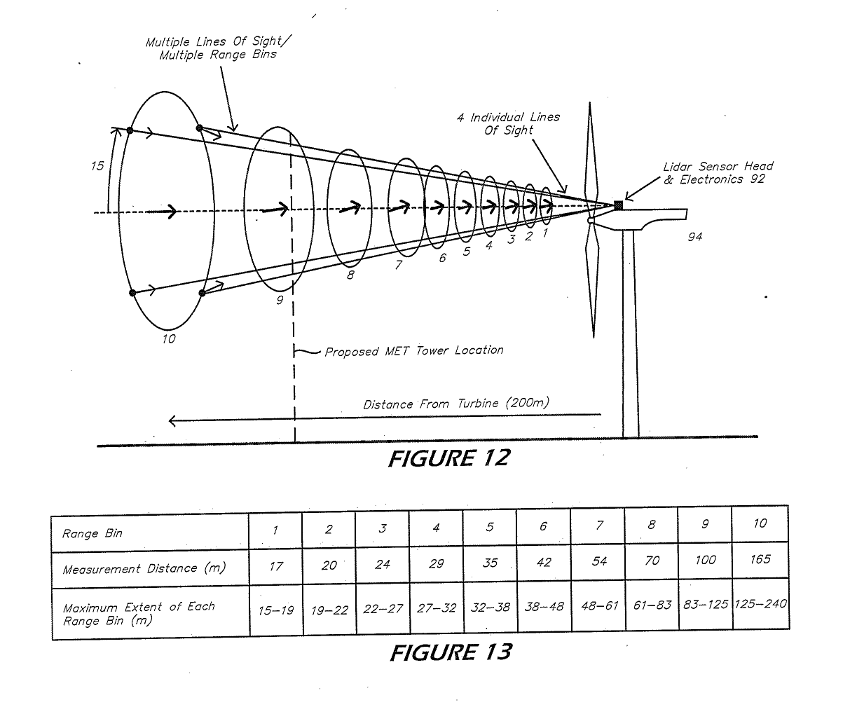

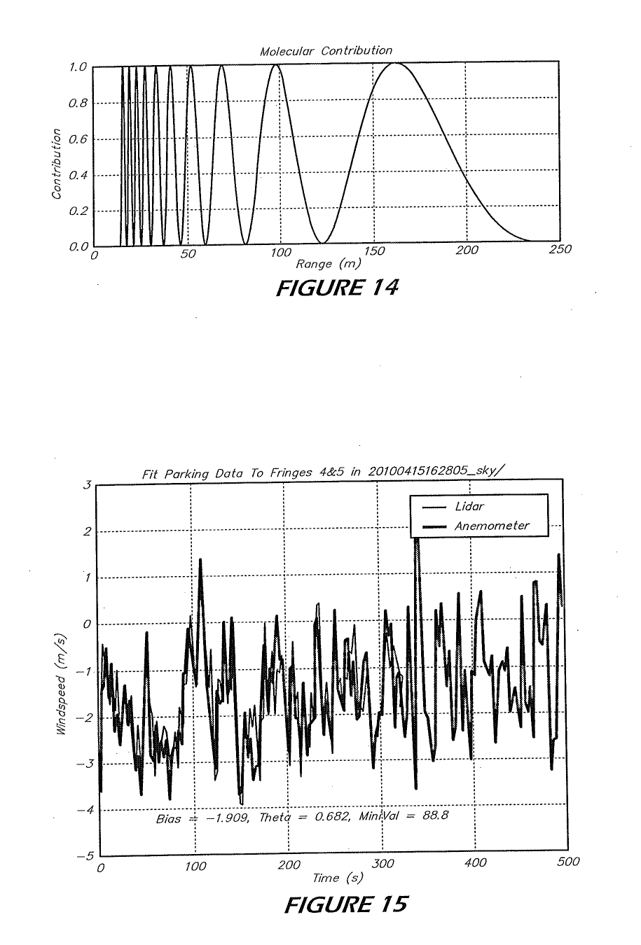

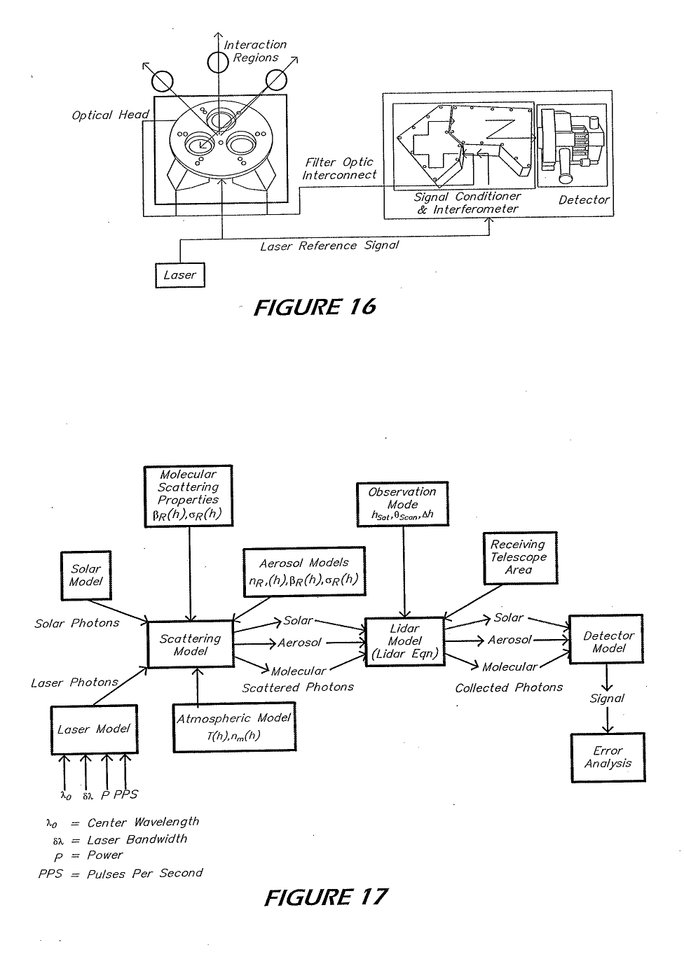

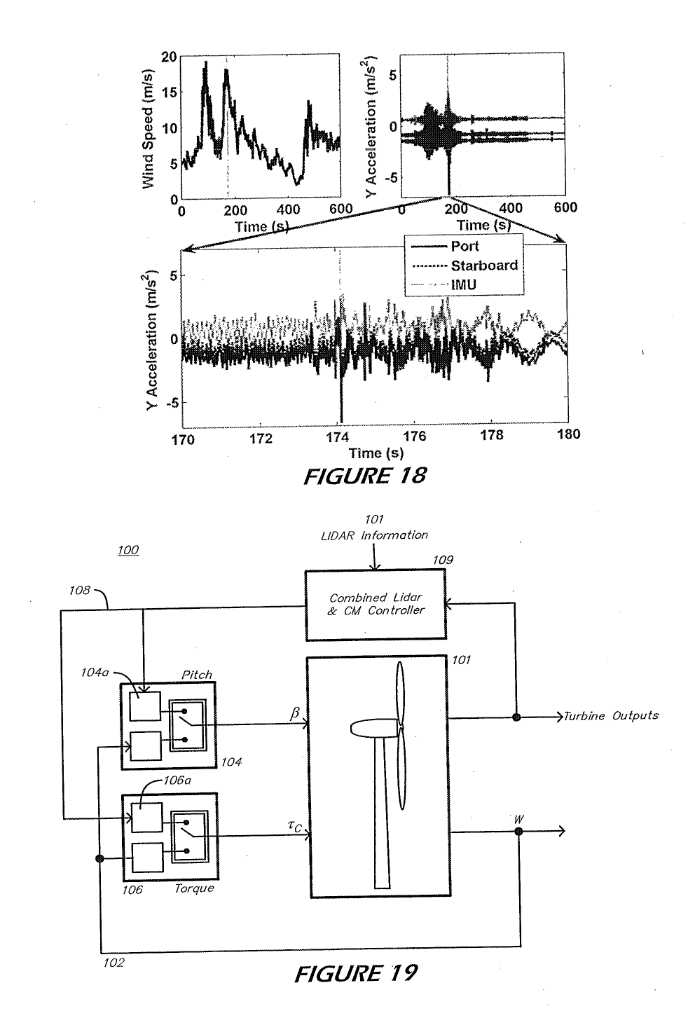

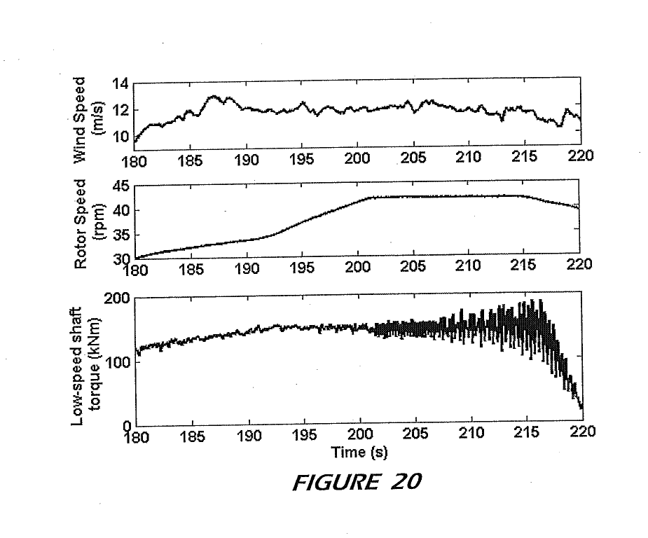

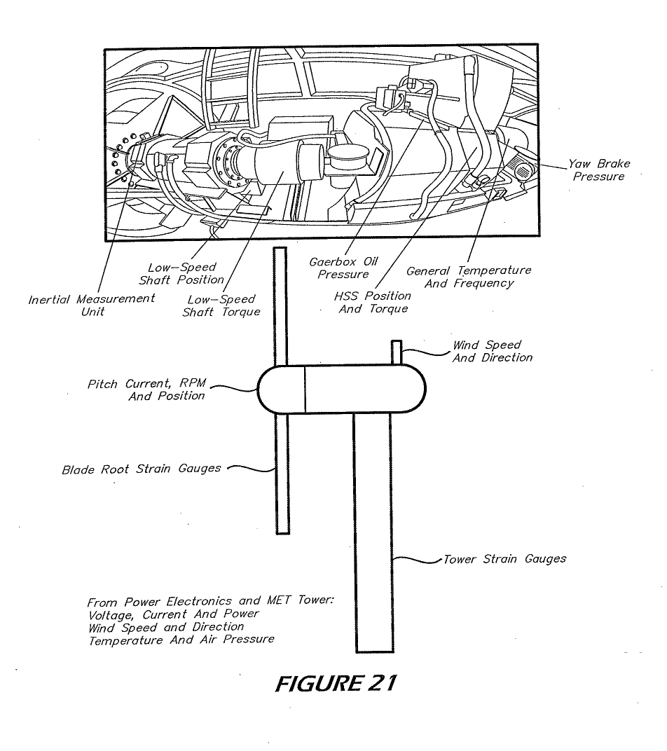

FIG. 12 illustrates an example implementation 90 of a range-imaging, direct detection instrument 92 on a wind turbine 94. The instrument 92 is mounted on top of the wind turbine nacelle 94 with sufficient height to allow a 15 degree cone angle. The LIDAR consists of four independent fields of view spaced 90 degrees from one another. The four fields of view will measure the wind at approximately ⅔ of the distance from the center-line to the blade tip at 100 m (range bin #9). This is how the 15 degree cone angle was selected. The instrument 92 also measures 10 range bins for each of the four lines of sight simultaneously, providing a true “snapshot” of the wind field. The maximum range of the instrument 92 is set at 200 m, but can be extended up to a kilometer. The purpose of 10 range bins is to provide greater spatial resolution for turbulence, shear, and gust tracking time of arrival. Having four independent fields of view also aids in the true measurement of the flow field since there is no delay due to scanning. The current location of the center of each range bin is provided in FIG. 13, along with the size (maximum and minimum measurement distance) associated with each range bin. The contribution to the measurement as a function of distance for each range bin is shown in FIG. 14. Note that a majority of the return signal or measurement is around the center of each range bin and that the edges of the range bin size contribute much less to the return signal.

Preliminary ground testing of the range-imaging, direct detection instrument with LIDAR systems measuring wind speeds accurately (sub-m/s) compared to anemometers, as shown in Figure. These measurements generate a more comprehensive picture of the atmosphere surrounding a turbine. They can be included in feed-forward fashion to the CM system of the present invention, allowing the turbine to respond proactively, before potentially damaging disturbances arrive.

An example of a non-ranging LIDAR that could be used with the present invention uses a 266-nm ultraviolet laser beam and a compact, fringe-imaging interferometer to detect the Doppler shift from backscatter produced by air molecules and aerosols. The geometry of the laser beam and the observing system are used to define the range from the sensor, rather than employing timing as is done with other LIDAR systems. This is analogous to the situation encountered by passive sensing space flight instruments, where the return signal is integrated along the line of sight. Wind speed and direction, density, and temperature are measured directly and used to determine the complete set of air data products.

In one configuration, the energy from the laser is subdivided into three beams that exit from the center of the optical head, typically at angles of 30°. It should be noted that scattering is detected only in regions where the laser beam intersects the field of view of the detecting telescope. This adjustable interaction region enables the measurement region to be tailored to the application. An example of LIDAR hardware is shown in Figure. The signal collected by the optical head is distributed through fiber optics, beam-expanded and passed through a series of filters to the Fabry-Perot interferometer to create the spectrum detected by the CCD.

To understand the impact of changing various LIDAR parameters, it is helpful to review the general LIDAR equation:

P_{S}=P_{L}*β*ΔR*Ω*T*η*G,

where:

P_{S} is the signal power on the detector

P_{L} is the laser power

β is the scattering coefficient

ΔR is the size of the range bin

Ω is the solid angle of the receiver

T is the transmission of the atmosphere

η is the system efficiency

G is a geometric beam overlap factor.

A LIDAR model that would be applicable to the present invention is depicted in graphical form in that can be incorporated into the implementation of FIG. 12 in accordance with the present invention;
Figure. The full model incorporates not only the LIDAR equation, but also properties of the atmosphere and solar radiation, the laser, and the detector. The detailed model allows for sensitivity and error analyses with respect to a range of atmospheric conditions.

### Fault Tolerant Control Strategies

In another aspect and example of the present invention, Smart Turbine control combines the predictive analytics CM software of the present invention with LIDAR-based controllers to form an optimal strategy for turbine control. In one strategy, the condition of the turbine and advanced measurement of the wind flow field can be used to determine an optimal solution for emergency, reconfigurable, or accommodating control, as described below.

Fault tolerant control is geared toward preventing minor problems from turning into major ones. It combines fault detection or condition monitoring with control strategies used to ensure safe operation (Blanke, 2001). It is a broad area of research consisting of numerous architectures, some of which fall into a “robust control” categorization, while others can be distinguished by being active or passive depending on their reactions to a detected fault.

Fault detection and fault-tolerant control for wind turbines are emerging fields with a great deal of interest, because wind turbines are large structures that are difficult to monitor effectively and typically costly to repair, especially for offshore turbines. Recent results in fault detection and fault-tolerant control for wind turbines include (Johnson 2011, Sloth 2011, Rothenhagen 2009, Amirat 2009, Odgaard 2009, Dobrila 2007, Caselitz 2005, and Verbruggen 2003, and NNES), all of which are hereby incorporated by reference. However, these and related papers have only scratched the surface of the field, and significantly more research is needed to ensure turbines are able to operate effectively in remote locations with little human intervention.

For wind turbines, faults can be categorized as sensor or component faults, where actuators may fall under the heading “component” or be treated separately. Component and actuator faults are likely to be safety critical, and sensor faults may be, especially when the sensors are used in feedback control. In that case, an inaccurate sensor could lead to an unstable feedback loop.

A critical element of fault-tolerant control is a thorough understanding of the system being controlled. For example, knowledge that the blades and associated pitch actuation are critical for operation and safety can significantly improve fault detection and fault avoidance. This speaks against a fully turnkey condition monitoring system: the integration of subject matter expertise into the control system is critical.

Estimation is a key area of fault detection, since many faults can be detected by comparing an actual sensor output to an estimate of what that output should be. The determination of the estimate may be model-based or data-based, and both of these simultaneously accommodated in the CM software of the present invention. In wind energy, the most uncertain signal is typically the wind speed input to the turbine, so the use of the optimizer system of the present invention with a LIDAR system has the potential to improve estimates of many other signals by a significant margin.

In addition, foreknowledge of the wind has the potential to prevent faults from occurring in a variation on fault-tolerant control. For example, FIG. A-18C show data from the National Renewable Energy Laboratory's (NREL's) Controls Advanced Research Turbine 2 (CART2) during a severe wind gust that triggered an emergency stop due to high accelerometer readings inside the turbine's nacelle. Although not strictly a fault in that the turbine was able to return to normal operation after the event without maintenance, the shut-down initiated by the protection system caused unnecessary down time for the turbine. Also, emergency stops are hard on turbine components, and therefore undesirable unless absolutely necessary. With LIDAR measurements in advance of the gust hitting the turbine, CART2's supervisory control may have been able to prevent the high accelerations from occurring and causing a load-inducing emergency stop.

The full system 100 of the present invention combines classical condition monitoring output from with forward-looking LIDAR data 101, shown conceptually in Figure, to select the optimal turbine control strategy for a wind turbine 101. In Figure, the paths 102 denote the traditional feedback control loops for turbine pitch 104 and generator torque 106, and the paths 108 denote the combined LIDAR-based feed-forward and CM-based fault-tolerant control strategy 109, which augments the primary turbine actuators 104a,106a of pitch and generator torque, respectively. The present invention is capable providing direct feedback (or feed-forward) data to accommodate several control and optimization scenarios, including:

Emergency Control

Reconfigurable Control

Accommodating Control

Sensor Optimization

These areas are discussed in detail below.

### Emergency Control

In the case of some detected critical faults, the only acceptable control action is to shut down the turbine in the safest way possible. In the case of a pitch actuator fault, that might mean controlling the pitch of the remaining blade(s) to a fully-feathered position and then setting the rotor brake or it might mean pitching the remaining blade(s) to feather at their maximum pitch rate while setting the rotor brake at the same time.

### Reconfiguration Control

In some cases, it may be possible to continue operation with little to no degradation in performance in response to a detected fault. The most common scenario in which no degradation may be possible is for the case of a sensor fault where either the sensor is not used in control or is closely related to another sensor, which can be used to estimate a correct value for the output of the failed sensor. The latter case is one example of reconfiguration. In this case, the controller structure can be augmented with an estimator such as a Kalman Filter that then provides the new input to the controller. Examples of closely related sensors that might be used include speed or torque sensors on the low- and high-speed shaft, which are related by the gear box ratio with some error due to torsion in the drive train. Other related sensors that may require more sophisticated estimation techniques include blade flap strain gauges and tower fore-aft strain gauges.

### Accommodating Control

In some cases it is not possible to continue operation without degradation. In this case, fault accommodating control may incorporate added constraints that may be necessary to ensure safe operation of the turbine. For example, CART3 has an unstable mode that drives increasing amplitude oscillations in the low-speed shaft torque near rated operation, as shown in FIG. 0. Extensive analysis has led human operators to accommodate this problem by reducing the rotor speed and power set points for above-rated operation, which results in a turbine producing less power than its nameplate rating. An accommodating fault-tolerant controller could be designed to perform the same function.

### Sensor Optimization

The CM system of the present invention provides a global picture of the turbine system. Feedback from the CM and observed turbine performance can be used to optimize turbine sensor selection and placement for fault detection and fault-tolerant control. Figure shows an example schematic of sensors on NREL's CART3.

### Smart Building Technology

In another embodiment of the present invention, most buildings are notoriously energy inefficient. Building managers today have few tools to optimize and manage the efficiency of the energy that their buildings consume. Current building energy management has focused almost entirely on providing comfort to the building occupants, and on minimizing the support calls to facility managers.

As a result, buildings may consume up to 30% more energy than would be needed if they were better managed. As new temperature, air pressure, and air flow sensors are incorporated into modern commercial buildings, and as ventilation, HVAC, and lighting systems become networked and accessible via the internet, it will become increasingly important to incorporate intelligent control strategies.

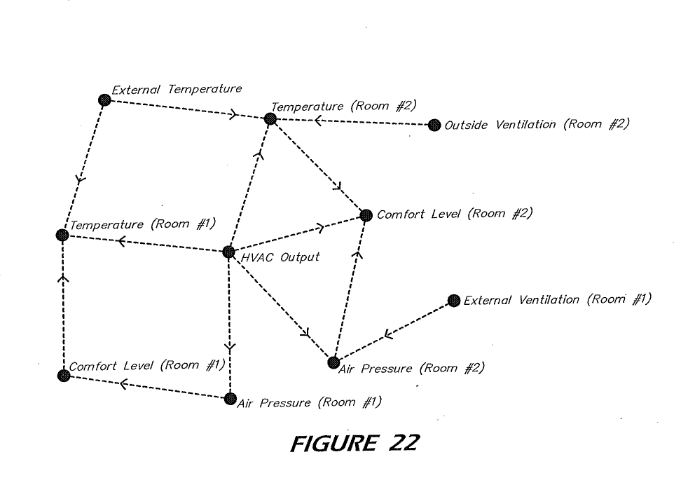

The reasoning and decision making systems of the present invention outlined hereinabove in the context of Smart Turbine technology, may similarly be used for Smart Building management. For example, as shown in FIG. 22, an influence diagram could implement a reasoning/decision strategy for a simple building consisting of two rooms, denoted #1 and #2. Sensors in the building provide information about the air pressure and temperature in these rooms. This information may be used to estimate the comfort in the room (as measured by the comfort utility nodes). Four decisions are available to the network, including activating hot or cold HVAC, and ventilating room #1 or room #2. The entire network may be solved to balance comfort in the two rooms against the cost of running the HVAC system. Stochastic control methods such as those discussed hereinabove such as SARSA or Q-learning can be used to learn optimal control strategies for maximizing the long-term utilities.

In reality, many more variables would be incorporated, including time of day, the number of people in each room (as measured by additional sensors), lighting status, outside air pressure, and so on. Additionally, the network would have access to more nuanced decisions: it could presumably control the HVAC temperature, the lights, ventilation airflow speed, etc.

### Smart Business Analytics

As with Smart Turbines and Smart Buildings, the automated reasoning and decision making tools of the present invention can also be used to help business managers make better informed decisions.

Businesses collect volumes of data, but making smart decisions based on that data is prohibitively difficult. Decision making is confounded by many factors, including: (1) Limited human and computational resources; (2) Difficulty synthesizing a coherent picture from volumes of manifold and (often) irrelevant data; (3) An inability to derive meaning from or detect structure in high dimensional data; and, (4) The randomness and uncertainty intrinsic to the real world.

Though these technical issues can be formidable, they are often eclipsed by a problem more fundamental. In many cases, a data mining effort is undirected and ineffectual because it is decoupled from the decision process itself. In particular, the following questions are not explicitly integrated into the analysis:
1. What are we trying to optimize? What decisions must be made? What decisions are available?
2. What are the costs and benefits of these decisions?
3. How do the available data sources relate to one another and to the available decisions?
   The core idea is this: data analysis in a vacuum is without value. If we are collecting and analyzing data—if we are mining it for structure, pattern, and meaning—it must be for a specific purpose, namely to optimize a particular outcome, and to make intelligent decisions in doing so.

The decision making technology of the present invention can be used for the purposes of decision making in the context of a business. Rather than sensor information, the business has access to other sources of data: last quarter's revenue, predicted profits for the next quarter, employee morale surveys, and so forth. Additionally, business managers have only a limited number of actions they can take. By building the influence diagram around this decision set, it becomes clear which data is necessary, and which is superfluous.

### Further Embodiments, Improvements & Variations

In accordance with the preceding description and drawings, exemplary embodiments of the present invention are directed to a system, method, and apparatus for performing resource optimization using environmental and condition-based monitoring. More particularly, exemplary embodiments can be implemented to perform resource optimization by coupling environmental and condition-based monitoring with automated reasoning and decision making technologies to optimize one or more objectives. Exemplary embodiments can be utilized to implement, for example, smart wind turbine control systems, smart building control systems, and control systems for any number and variety of other suitable applications that depend on smart business analytics. Exemplary embodiments can be utilized to implement control systems that determine optimal solutions and, based thereon, perform, for example, emergency control, condition-accommodating control, system reconfiguration, fault detection and fault-tolerant control, and system optimization.

Exemplary embodiments can further be implemented to utilize real-time situational awareness to perform time-dependent decision making in which decisions are determined and influenced based on a dynamically updating stream of monitoring data for both discrete and continuous random variables. Exemplary embodiments can be implemented to provide and rely on direct feedback and/or feed-forward data to implement systems for achieving any number and variety of control and optimization objectives. Exemplary embodiments can also be implemented according to and to accommodate probabilistic models and utility functions that may evolve over time, and exemplary embodiments can utilize automated learning and/or be reconfigurable.

For example, exemplary embodiments of the present invention are directed to a method for dynamically optimizing resource utilization in a system over time according to one or more objectives. The method includes dynamically updating a set of data including information indicative of current environmental conditions, upcoming environmental conditions, a current system configuration state, and current system operating conditions; periodically performing an automatic analysis of the set of data using a probabilistic model that is based on a set of conditional relationships defined between current environmental conditions, upcoming environmental conditions, system configuration states, and system operating conditions to periodically generate a set of possible system control actions; for each periodically generated set of possible system control actions, using the probabilistic model to automatically analyze an outcome of each possible system control action and select an optimal system control action from the set of possible system control actions based on a set of current utility functions formulated according to system performance priorities; and, for each periodically generated set of possible system control actions, performing control of the system according to the optimal system control action selected from the set of possible system control actions.

Some portions of the exemplary embodiments described above are presented in terms of and/or can be implemented according to algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in any suitable non-transitory storage medium or a transitory state medium, such as a network link and/or a network interface, including a wired network or a wireless network, which allow a computer system to read such computer readable information.

Condition-monitoring data may include signal measurements from the system to be controlled, collected at various, possibly asynchronous sampling rates. Environmental data for wind turbine systems, for example, may include measurements of the external conditions surrounding the system to be controlled, such as wind velocity, wind direction, temperature, density, water vapor, aerosol content, or pollution data measured by LIDAR or other sensors.

Specific instances of the environmental and condition monitoring data that may be collected and processed by the present invention include but are not limited to the examples listed below.

TABLE 1

| Wind Turbines | Smart Buildings | Business Analytics |
|---|---|---|
| Air temperature | Room air temperature | Total revenue |
| Air pressure | Room air pressure | Total profit |
| Air density | Room air density | Current operational |
| | | overhead |
| Wind speed, wind | Room light levels | Current cost of raw |
| direction, wind shear, | | materials |
| etc. from LIDAR | | |
| Blade torque | Room humidity | Inventory levels |
| Blade pitch | Air flow rates | Tax rates |
| Blade Pitch Rates | Perceived user comfort | Stock market data |
| Gearbox oil temperature | HVAC operating status | Total size of industry |
| Generator power | Exterior windows | Customer activation |
| | open? | rates |
| Generator voltage | Room doors open? | Current number of |
| | | customers |
| Nacelle ambient | Number of users | Customer retention |
| temperatures | in room | rates |
| High speed shaft power | Current cost of | Raw sales figures |
| | electrical power | |
| Low speed shaft power | Levels of sunlight | Projected sales figures |
| | incident on building | |
| Tower bending | Exterior air temperature | Customer satisfaction |
| moments | | survey data |
| Nacelle acceleration | Exterior air pressure | Total hours worked |
| (X-, Y- and Z-axis) | | by employees |
| Wind speed and direction | Exterior air density | Employee morale |
| (via anemometers and | | |
| wind vanes) | | |
| Expected monthly | Day of Week | Employee salaries |
| average temperature | | |

The data used by the present invention may be derived from any available data collection mechanism. A limited sample of possible collection mechanisms is presented below.

TABLE 2

| Collection Mechanism | Description |
|---|---|
| SCADA | Supervisory control and data acquistion systems— |
| | industrial control systems that monitor and control |
| | industrial infastructure and facilities |
| Acoustic, sound, | Devices designed to detect vibrations in different |
| and vibration | media, including microphones, geophones, |
| sensors | hydrophones, and other vibration sensing devices. |
| Imaging devices | Devices, such as CCD cameras, CMOS-based |
| | cameras, or 3D flash cameras, providing still or |
| | video image information (two dimensional or |
| | three dimensional) in the visible or |
| | other parts of the spectrum. |
| Electric current, | Sensors, such as voltage and ammeters, designed |
| voltage, and | to detect electrical current flow and voltage |
| magnetic sensors | differences. This class of sensors also includes |
| | devices such as magnetometers and Hall probes, |
| | which detect magnetic field levels. |
| Optical detectors | General devices that allow the user to detect or |
| | measure light, including photo-resistors, |
| | photomultiplier tubes, etc. |
| Proximity sensor | Sensors that sense the presence of nearby objects |
| | without physical contact. |
| Fluid flow sensor | Sensors designed to measure the rate of fluid flow. |
| | These might include specialized LIDAR sensors, |
| | anemometers, gas and water meters, etc. |
| Position, angle, | Sensors designed to measure the position and/or |
| displacement, | orientation of an object. These include laser range |
| speed, velocity, | finding devices, odometers, etc., as well as |
| and acceleration | devices designed to measure the speed and |
| sensors | acceleration of an object, such as tachometers, |
| | accelerometers, and IMUs. |
| Force sensors | Sensors that measure incident force. |
| Navigation | Devices, such as magnetic compasses, GPS |
| instruments | systems, altimeters, and gyroscopes that |
| | provide position and orientation |
| | information on Earth or in space. |
| Ionizing radiation | Devices that allow for the detection and |
| and other radiation | possibly the imaging of ionizing radiation, |
| detection and | including alpha, beta particles. |
| imaging devices | |
| Thermal, heat, and | Devices designed to sense or image heat in the |
| infrared sensors | environment. |
| Pressure sensors | Devices such as barometers, tactile switches, |
| | or touch sensitive devices that translate pressure |
| | variations into data |
| Web APIs | An application protocol interface (API) allows an |
| | application to remotely (via, e.g., the internet) |
| | access information from another application. |
| | An API might provide access to weather |
| | information, stock prices, or other publicly |
| | or privately accessible data. |
| Crowd-sourced | Systems, including survey systems, designed |
| data collection | to elicit specific information from a small or |
| | large number of users. Users could be employees |
| | in an organization, the customer base, or |
| | other relevant stakeholders. |
| Automated data | Data mining and processing systems, such as |
| mining systems | natural language processors, clustering engines, |
| | etc., which pull data from one or more sources, |
| | including the internet, social media, and other |
| | sensor systems, and further process it into |
| | actionable data. |
| Chemical sensors | Sensors that measure the relative amounts of |
| | specific chemicals in a given sample, including, |
| | for example, a mass spectrometer, a carbon |
| | monoxide sensor, a fire alarm, etc. |

In addition to raw data, the present invention allows a user to specify utility or objective functions in order to modify system performance priorities. These utility functions can take any functional form, and may have any number of quantities as inputs. Indeed, they need not be functions in the mathematical sense at all: they can be algorithms that respond in a complex, conditional manner to their array of inputs. A limited list of possible utility functions is presented in Table 3 hereinbelow.

TABLE 3

| Name of | |
|---|---|
| Utility Function | Description |
| Cost of energy | For a wind turbine system, the total cost of producing a |
| | given unit (say, 1 kWh) of energy. Since higher utilities |
| | express greater preference, this function returns the |
| | negative of the cost of producing 1 kWh, factoring |
| | in all transportation, maintenance, repair, |
| | and other labor costs |
| Cost of repair | The cost of repairing a wind turbine or other machine |
| | given the failure of one of its components. |
| Customer | Customer happiness, as measured by a dimensionless |
| happiness | quality, estimated from a number of factors, including |
| | retention rate, customer surveys, and so forth. |
| Total sales | Total sales revenue for a company |
| User comfort | In a smart building application, this utility function |
| | quantifies the comfort level of individuals, as a function |
| | of room temperature, pressure, humidity, and lighting |
| | levels. Comfort is here measured in dollars, so this |
| | comfort can be simultaneously optimized against total |
| | cost of operating the building. |
| Employee | A measure of the happiness of employees in the |
| morale | company, which can be maximized along with |
| | productivity, profits, etc. |
| Cost of training | The cost of training a new employee, given that the |
| | new hire is new to the industry. |

As emphasized earlier, raw data sources and utility functions are only useful in the context of a set of available decisions or actions. An example set of such decisions is presented below.

TABLE 4

| Name of Action | Description |
|---|---|
| Pitch wind turbine | In a wind turbine system, sensor data and utility |
| blades | functions can be used to optimally decide when to |
| | pitch wind turbine blades to avoid castastrophic damage |
| Repair turbine | Given vibration and other sensor data, a turbine may |
| | automatically decide to request a repair on a certain |
| | gearbox component to avoid catastrophic damage. |
| Buy/sell stock | Organizations or individuals may decide to buy or sell |
| | stock as markets fluctuate, tolerance for risk evolves, |
| | and as new innovations are made. |
| Open/close | Smart building systems may elect to open or close |
| ventilation ducts | certain vents in order to best regulate building climate. |
| User comfort | In a smart building application, this utility function |
| | quantifies the comfort level of individuals, as a function |
| | of room temperature, pressure, humidity, and lighting |
| | levels. Comfort is here measured in dollars, so this |
| | utility may be simultaneously optimized against total |
| | cost of operating the building. |
| Hire new | During a period of growth, a company may find it |
| employees | necessary to hire new employees in order to sustain that |
| | growth. This decision can be influenced by a number of |
| | sensor data inputs, including cost of the employee, his |
| | expected performance, the rate of company growth, etc. |

Given the types of data the present invention can process, and the diversity of possible mechanisms by which this data may be obtained, it is critical that clear probabilistic relationships be established between the different quantities. There are three types of links between the different quantities: Decisions, Utilities, and Variables, as summarized in Table 5 hereinbelow.

TABLE 5

| Name of Link | Description |
|---|---|
| Causal Influence | This directed link exists between two random variables, |
| Link | and indicates that the parent is a cause of the child. This |
| | causality is encoded in the conditional probability |
| | distribution; that is, the expression which specifies the |
| | probability of the child, given the value of the parent. |
| Decision Link | A directed link from a Utility of Variable node to a |
| | Decision node. This link indicates that the information |
| | associated with the parent is present when the decision |
| | associated with the child Decision node is to be made. |
| Functional Link | A directed link from a Variable or Decision node into a |
| | Utility node. This indicates a functional dependence of |
| | the Utility node on all of its parent nodes. |

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations, need be implemented in methods, systems, and/or apparatuses including one or more concepts describe with relation to exemplary embodiments of the present invention.

Therefore, it is intended that the invention not be limited to the particular embodiments disclosed as the best mode contemplated for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. §112, sixth paragraph, unless the element is expressly recited using the phrase “means for” or “step for.” These following claim(s) should be construed to maintain the proper protection for the present invention.

We claim:

1. A method for dynamically optimizing resource utilization in a system over time according to one or more objectives, the method comprising:
dynamically updating a set of data including information indicative of current environmental conditions, upcoming environmental conditions, a current state of a system configuration, and current system operating conditions;
periodically performing an automatic analysis of the set of data using a probabilistic model that is based on a set of conditional relationships defined between current environmental conditions, upcoming environmental conditions, system configuration states, and system operating conditions to periodically generate a set of possible system control actions;
for each periodically generated set of possible system control actions, using the probabilistic model to automatically analyze an outcome of each possible system control action and select an optimal system control action from the set of possible system control actions based on a set of current utility functions formulated according to system performance priorities; and
for each periodically generated set of possible system control actions, performing control of the system according to the optimal system control action selected from the set of possible system control actions.
